(19) United States
(12) Patent Application Publication
(10) Pub. No.: US 2019/0301321 A1
(43) Pub. Date: Oct. 3, 2019

(54) EXHAUST GAS SYSTEM FOR AN INTERNAL COMBUSTION ENGINE OF A MOTOR VEHICLE

(71) Applicant: Faurecia Emissions Control Technologies, Germany GmbH, Augsburg (DE)

(72) Inventor: Benjamin BINDER, Augsburg (DE)

(21) Appl. No.: 16/365,814

(22) Filed: Mar. 27, 2019

(30) Foreign Application Priority Data
Mar. 29, 2018 (DE) 10 2018 107 531.6

(51) Int. Cl. F01N 1/06; F01N 13/08

(52) U.S. Cl. CPC F01N 1/065; G10K 2210/1282; F01N 2470/04; F01N 13/08

(57) ABSTRACT

An exhaust gas system for an internal combustion engine of a motor vehicle includes at least one exhaust gas line and an active sound-generation device, which comprises a sound line with a mouth that opens into the exhaust gas line and is connected to an electrical sound source. A housing surrounds at least one portion of the exhaust gas line arranged downstream of the mouth of the sound line into the exhaust gas line when viewed in a flow direction of the exhaust gas. The said housing is connected to an error sensor and a cavity is formed between an outer side of the exhaust gas line and an inner side of the housing. The at least one portion of the exhaust gas line extending in the housing has at least one opening that opens into the cavity.

### CROSS-REFERENCE TO RELATED APPLICATIONS

This application is a U.S. non-provisional application claiming the benefit of German Patent Application No. 10 2018 107 531.6, filed on Mar. 29, 2018, which is incorporated herein by its entirety.

### FIELD OF INVENTION

The present invention relates to an exhaust gas system for an internal combustion engine of a motor vehicle that includes at least one exhaust gas line and an active sound-generation device.

### BACKGROUND OF THE INVENTION

In modern vehicles, it is known to provide active sound-generation devices, e.g. loudspeakers, in the vehicle exhaust gas system in order to be able to influence the engine noise of the internal combustion engine of the vehicle.

Sound-generation devices of this type can be used in particular to generate low-frequency noises, for example, in order to muffle the engine noise. It is also possible to optimize the sound of an engine in the area surrounding the vehicle. To do so, the sounds waves from the sound-generation device are superimposed on the sound waves emanating from the engine.

The sound-generation devices operate in a closed control loop. This means that feedback is provided, which is used to detect deviations from a desired engine noise and to accordingly optimize a noise generated by the sound-generation device. For this purpose, an error sensor is provided, which is connected to the exhaust gas system.

To obtain good sound quality of the engine noise, the recorded error signal must be of the best possible quality. To achieve this, the error sensor must be arranged at a sufficient distance from a sound source, in particular at a point at which the different sound waves have already undergone sufficient superposition. However, the pressure distribution along the exhaust gas line is not uniform; in particular, the position of nodes and anti-nodes of a sound wave along the exhaust gas line varies, making it difficult to obtain accurate measurements.

The object of the present invention is thus to provide an exhaust gas system for an internal combustion engine of a motor vehicle, with at least one exhaust gas line and an active sound-generation device with which a particularly high-quality engine noise can be generated.

### SUMMARY OF THE INVENTION

The present invention provides an exhaust gas system for an internal combustion engine of a motor vehicle that includes at least one exhaust gas line and an active sound-generation device which comprises a sound line having a mouth which opens into the exhaust gas line and is connected to an electrical sound source. A housing surrounds at least one portion of the exhaust gas line arranged downstream of the mouth of the sound line when viewed in a flow direction of the exhaust gas. The housing is connected to an error sensor and a cavity is formed between an outer side of the exhaust gas line and an inner side of the housing. The at least one portion of the exhaust gas line extending in the housing has at least one opening that opens into the cavity.

An exhaust gas system of this type has the advantage whereby sound and/or pressure waves present in the region of the exhaust gas line undergo superposition in the cavity of the housing. As a result, the error sensor can record a more effectively blended signal than if the error sensor were connected to just one measurement point along the exhaust gas line. The engine noise can thus be influenced, in particular optimized, in a more targeted manner. In addition, the error sensor can be positioned flexibly along the exhaust gas line depending on the installation space situation, since the sound waves undergo sufficient superposition in the housing even close to the sound source.

The portion of the exhaust gas line surrounded by the housing is straight or curved, for example. The exhaust gas system can thus be adapted to the installation space situation in the motor vehicle. The error sensor is designed to measure pressure fluctuations and static pressure conditions. For example, the error sensor is a microphone connected to a control unit.

According to one embodiment, the at least one opening forms a perforated region. The perforated region forms an acoustically transparent region in the exhaust gas line, such that sound waves can propagate from the particular line into the cavity, where they can undergo superposition. The pressure inside the housing contains the pressure signals that arise out of the exhaust gas line along the entire perforation. This leads to the signals being physically averaged along the perforated region, and to high accuracy in the error signal measured by the error sensor.

The perforated region can comprise slots, holes and/or microperforations. Each of these variants is suitable for forming a sufficiently acoustically transparent opening.

In the context of the present invention, microperforations are deemed to be perforations having a maximum pore size of 2.0 mm². Preferred pore sizes are between 0.05 mm² and 1.5 mm². In this regard, suitable pore shapes include circles, circle segments, ovals, trapeziums, slots and the like. In terms of the pore sizes, widths of between 0.05 mm and 0.15 mm and lengths of between 0.5 mm and 1.5 mm have proven particularly favourable for non-round pores.

Alternatively or additionally, the opening can run in a circumferentially closed manner so as to form two spaced-apart line portions. In other words, a portion of the exhaust gas line can be cut out. This forms a region that is completely acoustically transparent.

In all the aforementioned embodiments, the exhaust gas line can extend beyond the housing on both sides, such that the line runs into the housing on one side and runs out of the housing on an opposite side. Alternatively, if the exhaust gas line is curved, the exhaust gas line can run into the housing at one end face and run out of the housing at a side wall thereof. In a further alternative embodiment, the housing can be adapted to the geometry of the exhaust gas system and can, for example, also be curved.

Alternatively, an outlet end of the exhaust gas line can terminate at the housing. As a result, the exhaust gas system can have a particularly compact design. In addition, in this embodiment the housing can simultaneously form a pipe end cover.

According to a further embodiment, the opening can form a space between an end of the exhaust gas line and a downstream end of the housing. This embodiment is advantageous in terms of production costs since there are fewer connection points between the housing and the exhaust gas line. In particular, an outlet end of the exhaust gas line is arranged in a free-standing manner in the housing. In this embodiment too, the housing can replace an additional pipe end cover.

Preferably, the exhaust gas line and the sound line together form a double-D pipe in one portion. In particular, the exhaust gas line and the sound line have a shared wall in one portion. As a result, the sound waves of the sound line and of the exhaust gas line can be superimposed on one another particularly effectively. This has a positive effect on the sound quality of the exhaust gas system, in particular on the engine noise heard by a person standing close to the exhaust gas system. This portion, in particular the double-D pipe, preferably terminates upstream of the housing surrounding the exhaust gas line. For example, the mouth of the sound line into the exhaust gas line is arranged at the end of this portion.

The housing may coaxially surround the exhaust gas line. The cavity formed between the outer side of the exhaust gas line and the inner side of the housing is thus symmetrical around the exhaust gas line. As a result, the sound waves undergo particularly effective superposition in the housing. Alternatively, however, the housing may also be asymmetrical. The geometry of the housing can thus be adapted to the surrounding installation space.

According to a preferred embodiment, an absorption material can be arranged in the cavity, and can possibly fill the cavity. By way of example, the absorption material is glass wool, rock wool or a wire mesh. Via the absorption material, the error sensor can be shielded against high-frequency sound waves. High-frequency sound waves of this type may be produced by flows along the perforations. In particular, the absorption material acts as a physical filter, in particular as a high-frequency filter, and specifically in the direction of the error sensor and in the direction of the outlet end of the exhaust gas line. This makes it possible to use simpler controllers in batch production.

The error sensor is preferably in flow communication with the cavity via a line. The error sensor can thus measure the signal that has been well blended in the cavity.

### BRIEF DESCRIPTION OF THE DRAWINGS

FIG. 1 is a schematic diagram of an exhaust gas system according to the invention for an internal combustion engine of a motor vehicle,

FIG. 2 is a cross section through an exhaust gas line and a sound line of the exhaust gas system in a region upstream of a mouth of the sound line into the exhaust gas line,

FIG. 3 is a schematic sectional view of a portion from one example embodiment of the exhaust gas system according to the invention,

FIG. 4 is a schematic sectional view of a portion from another example embodiment of the exhaust gas system according to the invention,

FIG. 5 is a schematic sectional view of a portion from another example embodiment of the exhaust gas system according to the invention,

FIG. 6 is a schematic sectional view of a portion from another example embodiment of the exhaust gas system according to the invention,

FIG. 7 is a schematic sectional view of a portion from another example embodiment of the exhaust gas system according to the invention, and

FIG. 8 is a schematic sectional view of a portion from another example embodiment of the exhaust gas system according to the invention.

### DETAILED DESCRIPTION

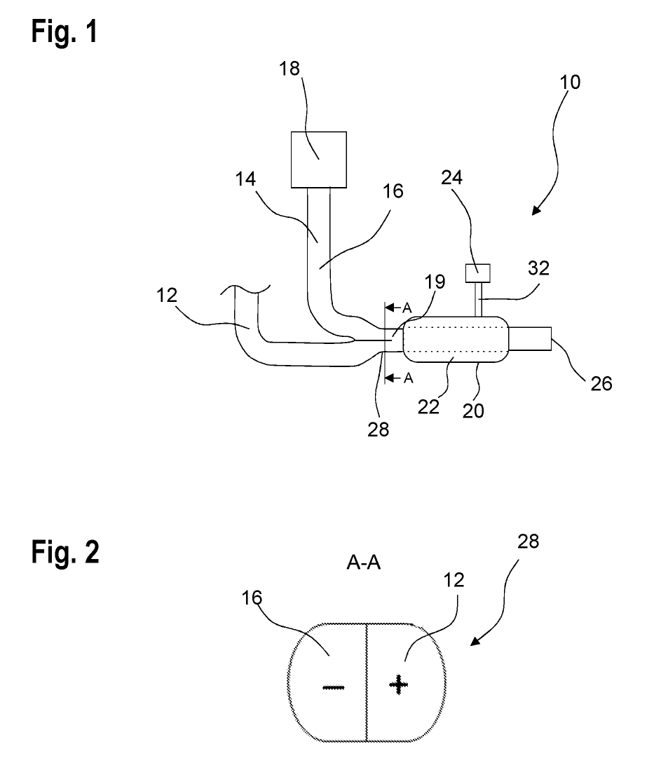

FIG. 1 schematically shows an exhaust gas system 10 according to the invention for an internal combustion engine of a motor vehicle.

The exhaust gas system 10 comprises an exhaust gas line 12 and an active sound-generation device 14 which comprises a sound line 16 which opens into the exhaust gas line 12 and is connected to an electrical sound source 18. The sound source 18 is a loudspeaker, for example. Via the sound-generation device 14, an undesirable engine noise can be muffled and/or a desired engine noise can be constructed. For example, customers associate certain noises with high engine performance or a high-quality engine. In a portion arranged downstream of a mouth 19 of the sound line 16 into the exhaust gas line 12 when viewed in a flow direction of the exhaust gas, the exhaust gas line 12 is surrounded by a housing 20, wherein a cavity 22 is formed between an outer side of the exhaust gas line 12 and an inner side of the housing 20. By way of example, the housing 20 is an elongate sleeve which surrounds, in particular coaxially encloses, the exhaust gas line 12.

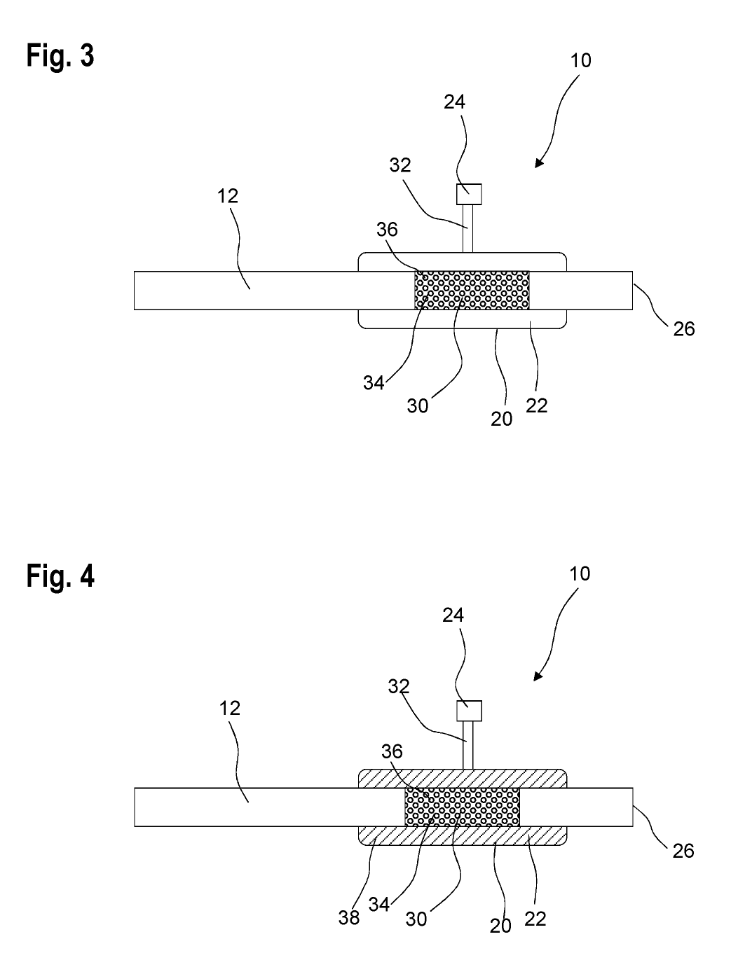

The portion of the exhaust gas line 12 extending in the housing 20 has at least one opening 30 which opens into the cavity 22. FIGS. 3 to 8 schematically show various possible forms of the opening 30. The openings 30 are acoustically transparent and allow sound waves to propagate out of the exhaust gas line 12 into the cavity 22, where they undergo superposition.

The housing 20 is in flow communication with an error sensor 24, for example via a flexible hollow line 32. The error sensor 24 is a microphone, for example.

The mode of operation of the exhaust gas system 10 and the sound-generation device 14 will be explained below:

During engine operation, exhaust gas flows in the exhaust gas line 12 towards an outlet end 26 of the exhaust gas system 10. In the process, at least some of the noise generated by the engine itself propagates in the exhaust gas line 12 in the form of sound waves. At the same time, the sound waves of the noises generated by the sound source 18 propagate in the sound line 16 and, downstream of the mouth 19, also in the exhaust gas line 12. In the region in which the exhaust gas line 12 and the sound line 16 run in parallel, the sound waves emanating from the engine and the sound source 18 are superposed. This actively influences the engine noise.

In the embodiment shown, the exhaust gas line 12 and the sound line 16 are merged in a Y-shaped portion and, in a region downstream of the Y-junction, extend in one portion in parallel with and separately from one another in a double-D pipe 28. This portion terminates upstream of the housing 20. FIG. 2 shows a cross section through the double-D pipe 28.

To obtain an optimum engine noise, feedback is provided. For this purpose, the error sensor 24 measures the pressure conditions in the cavity 22, in particular pressure fluctuations and the static pressure, upon which the sound waves generated by the sound source 18 are adapted as required.

Since the error sensor 24 is in flow communication with the housing 20, the error sensor 24 can identify an error signal to a particularly high degree of accuracy.

FIGS. 3 to 8 illustrate various embodiments of the invention which differ in particular on account of the shape of the opening 30. In each case a part of the exhaust gas system 10 that comprises the housing 20 is shown schematically.

FIG. 3 shows an embodiment according to the invention of the exhaust gas system 10 in which the opening 30 forms a perforated region 34 in the exhaust gas line 12. Here, the perforated region 34 comprises holes 36. Alternatively or additionally, however, the perforated region 34 can be formed by slots or microperforations. Sound waves can propagate along the perforated region 34 out of the exhaust gas line 12 into the cavity 22 of the housing 20.

FIG. 4 shows a further embodiment of the exhaust gas system 10 which differs from the embodiment shown in FIG. 3 in that an absorption material 38 is additionally provided in the cavity 22. This serves as a physical filter, in particular as a high-frequency filter, in order to shield the error sensor 24 against high-frequency sound waves. In addition, the absorption material 38 muffles high-frequency external noises at the outlet end 26 of the exhaust gas line 12.

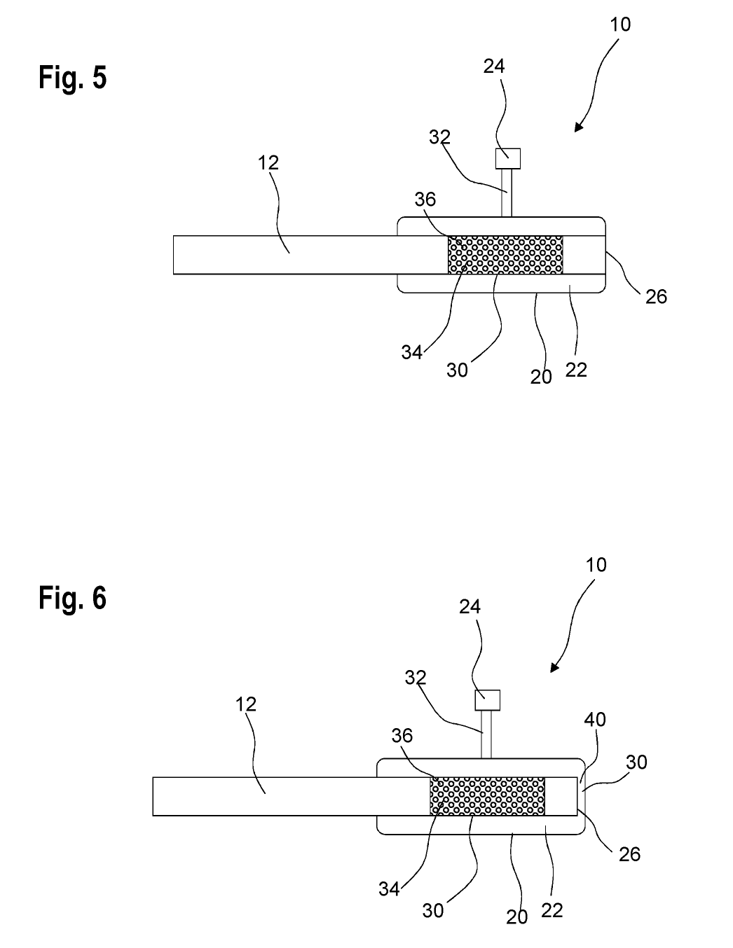

FIG. 5 shows a further embodiment of the exhaust gas system 10 which differs from the embodiment shown in FIG. 3 in that, at its outlet end 26, the exhaust gas line 12 terminates flush with a downstream end of the housing 20. This achieves a compact design of the exhaust gas system 10. At the same time, the housing 20 forms a pipe end cover for the exhaust gas line 12. This is advantageous in that the number of required components is reduced, whereby the exhaust gas system 10 is cost-effective to produce.

In the embodiment of the exhaust gas system 10 shown in FIG. 6, the exhaust gas line 12 terminates in the housing 20. As a result, there is formed in addition to the perforated region 34 an additional opening 30 which forms a space between an end 26 of the exhaust gas line 12 and a downstream end of the housing 20, in which an outlet opening of the housing 20 is provided.

Therefore, the sound waves can propagate not only through the perforated region 34 into the cavity 22 of the housing 20, but also through a gap formed between the housing and the exhaust gas line 12. As a result, the sound waves can undergo even more effective superposition in the housing 20.

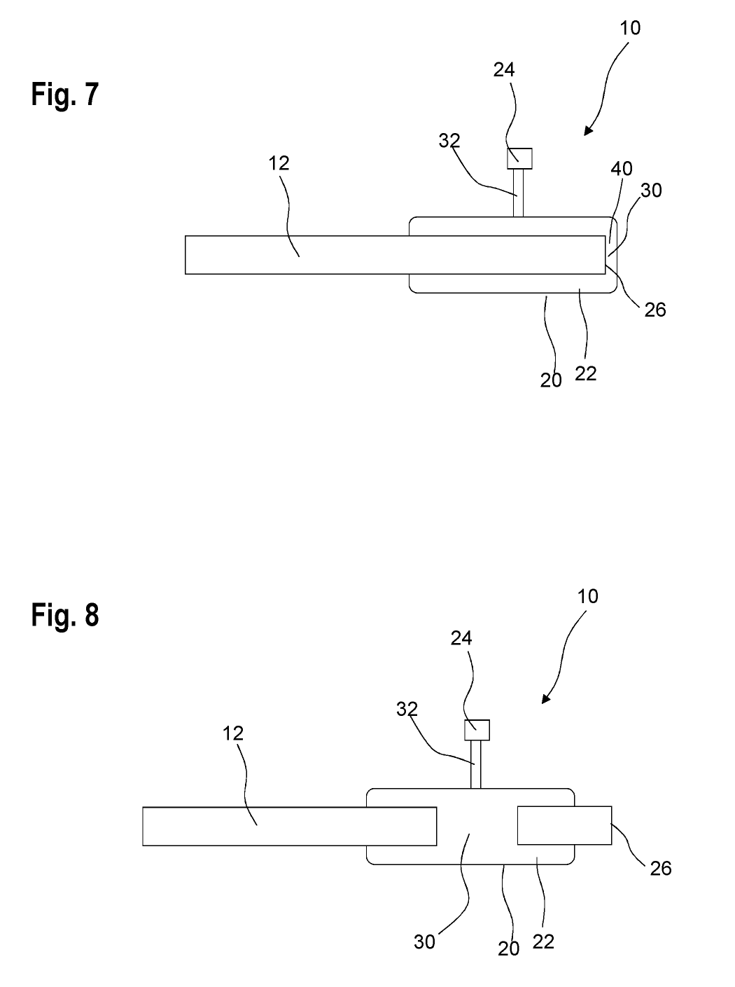

FIG. 7 shows a further embodiment of the exhaust gas system 10, which differs from the embodiment shown in FIG. 6 in that there is no perforated region 34; instead, the opening 30 is formed solely by a space between an end 26 of the exhaust gas line 12 and a downstream end of the housing 20. Here also, the right-hand wall of the housing 20 has an outflow opening. This embodiment is particularly cost-effective to produce.

FIG. 8 shows a further embodiment of the exhaust gas system 10, in which the opening 30 runs in a circumferentially closed manner so as to form two spaced-apart line portions. This opening 30 has a maximum possible acoustic transparency, with the result that sound waves can propagate into the cavity 22 unhindered.

Although an embodiment of this invention has been disclosed, a worker of ordinary skill in this art would recognize that certain modifications would come within the scope of this disclosure. For that reason, the following claims should be studied to determine the true scope and content of this disclosure.

1. An exhaust gas system for an internal combustion engine of a motor vehicle comprising:
at least one exhaust gas line;
an active sound-generation device comprising a sound line having a mouth which opens into the exhaust gas line and is connected to an electrical sound source; and
a housing that surrounds at least one portion of the exhaust gas line arranged downstream of the mouth of the sound line when viewed in a flow direction of exhaust gas, said housing being connected to an error sensor, wherein a cavity is formed between an outer side of the exhaust gas line and an inner side of the housing, and wherein the at least one portion of the exhaust gas line extending in the housing has at least one opening that opens into the cavity.

2. The exhaust gas system according to claim 1, wherein the at least one opening forms a perforated region.

3. The exhaust gas system according to claim 2, wherein the perforated region comprises slots, holes, and/or microperforations.

4. The exhaust gas system according claim 1, wherein the at least one opening runs in a circumferentially closed manner to form two spaced-apart line portions.

5. The exhaust gas system according to claim 1, wherein the at least one opening forms a space between an end of the exhaust gas line and a downstream end of the housing.

6. The exhaust gas system according to claim 1, wherein the exhaust gas line and the sound line together form a double-D pipe in one portion.

7. The exhaust gas system according to claim 6, wherein the housing coaxially surrounds the exhaust gas line.

8. The exhaust gas system according to claim 1, wherein an absorption material is arranged in the cavity.

9. The exhaust gas system according to claim 1, wherein the error sensor is in flow communication with the cavity via a line.
